(19) United States
(12) Patent Application Publication
(10) Pub. No.: US 2025/0187215 A1
(43) Pub. Date: Jun. 12, 2025

(54) DUAL BLADE-DEPTH CARPET KNIFE

(71) Applicant: Q.E.P. Co. Inc., Boca Raton, FL (US)

(72) Inventors: Bradley Scott MILLER, Boca Raton, FL (US); Joseph DEGUGLIMO, West Palm Beach, FL (US)

(73) Assignee: Q.E.P. Co. Inc., Boca Raton, FL (US)

(21) Appl. No.: 18/942,918

(22) Filed: Nov. 11, 2024

Related U.S. Application Data
(63) Continuation-in-part of application No. 18/533,738, filed on Dec. 8, 2023.

(51) Int. Cl. B26B 5/00

(52) U.S. Cl. CPC B26B 5/001; B26B 5/005

(57) ABSTRACT

A dual blade-depth knife having a head, a body, and a first end at one end of the head, and a blade positioning member for retaining a blade in a first position with a blade end at a first distance from said first end and for retaining a blade in a second position with a blade end at a second distance from said first end, with the first and second positions being offset relative to each other in a direction outwardly from the head. A blade storage holder internal to the knife for storing one or more individual blades and for storing a cartridge containing multiple blades.

### CROSS-REFERENCE TO RELATED APPLICATION

This application is a continuation-in-part of prior U.S. patent application Ser. No. 18/533,738 filed on Dec. 8, 2023, the entirety of which is hereby incorporated by reference.

### FIELD

This application relates to a dual blade-depth carpet knife to accommodate cutting different carpet and/or carpet back materials and thicknesses. In addition, this application relates to a knife which provides for storage of used blades, one or more individual replacement blades and/or cartridges or packages of multiple replacement blades.

### BACKGROUND

The subject matter discussed in this background section should not be presumed to be prior art or analogous art merely as a result of its inclusion in this section. Similarly, a problem mentioned in this section or associated with the subject matter of this section should not be presumed to have been previously recognized in the prior art. Rather, the subject matter in this section merely represents different approaches, which, in and of themselves, may also be inventions.

In a variety of professional crafts, as well as in a variety of “do-it-yourself” or “DIY” activities, it is often desirable, frequently preferred, and potentially necessary, to have a carpet knife that is readily available to cut at different depths depending upon the thickness of the carpet and/or the carpet backing. In addition, it is potentially necessary to have a carpet knife that may cut carpeting of different materials which provide different resistance to a cutting force.

A traditional carpet knife blade is an extremely thin rectangular blade, typically with multiple cutting edges, and with corners which make it harder to accidentally cut too deep through the carpet and thus make it harder to accidentally damage anything beneath the carpet such as hardwood flooring.

However, a conventional carpet knife blade has a propensity to snap if the blade unnecessarily extends outwardly too great a distance from the knife handle. On the other hand, the blade should extend a sufficient distance so that carpets and/or carpet backings of substantial thickness and/or resistance to cutting can, in fact, be cut by the blade.

Therefore, a need exists to balance the foregoing requirements by providing a carpet knife that can provide distinct cutting blade depths for the same blade, for example, a carpet knife with at least dual cutting blade depths.

In addition, knife blades in general, and carpet cutting blades in particular, may become dull from extensive use and/or may snap despite the benefit of the multiple blade depth feature described in the preceding paragraphs.

A carpet cutting knife typically does not have a fully retracted blade position. As a result, care must be taken when storing such a knife, preferably by removing and discarding a used blade. However, if the blade has a meaningful remaining useful life, it is preferred not to discard the blade. This creates the additional problem of how to store a knife that does not have a fully retracted blade position.

Replacement blades are typically sold individually as well as in multiple blade cartridges. The user of the knife frequently has one or more individual replacement blades and/or a blade cartridge available to facilitate replacement of blades.

However, prior to the present invention, there was no convenient way for the user to store used blades, replacement blades and/or or blade cartridges.

### SUMMARY

A dual blade-depth carpet knife that provides distinct cutting blade depths but preferably not a fully retracted blade position.

A knife, preferably a carpet knife, that provides for convenient storage of one or more individual used or replacement blades and for convenient storage of blade cartridges.

In a non-limiting embodiment, the knife includes an insert that may be used to establish multiple, distinct cutting blade depths.

In a non-limiting embodiment, the knife includes a swivel retainer that may be used for storage of individual used and/or replacement blades and/or for storage of blade cartridges, each in their proper position within the knife.

### BRIEF DESCRIPTION OF THE FIGURES

In the following drawings, like reference numerals are used to refer to like elements. Although the following figures may depict a single embodiment or example, the figures should not be interpreted in isolation but rather in the context of the specification and thus the invention is not limited to the embodiment or example depicted.

FIG. 1 is a side view of the front of a carpet knife;

FIG. 2 is a side view of the rear of a carpet knife;

FIG. 3 is a side view of the interior of a carpet knife rear cover;

FIG. 4 is a side view of the interior of a carpet knife front cover;

FIG. 5 is a front view of a blade positioning member;

FIG. 6 is a rear view of a blade positioning member;

FIG. 7 is a front view of a carpet knife blade;

FIG. 8 is a front view of a carpet knife blade in extended to one position in a blade positioning member;

FIG. 9 is a front view of a carpet knife blade in extended to a second position in a blade positioning member;

FIG. 10 is a partial view of blade positioned in one position in the head of a knife;

FIG. 11 is a partial view of blade positioned in a second position in the head of a knife;

FIG. 12 is a perspective view of a blade holder;

FIG. 13 is an illustration of a blade on a blade holder;

FIG. 14 is an illustration of a package or cartridge which may contain blades with the cartridge retained on a blade holder; and

FIG. 15 is a partial illustration of a blade holder in the rear cover of the knife.

### DETAILED DESCRIPTION

Although various embodiments or examples of the invention may have been motivated by various deficiencies with the prior art which may be discussed or alluded to in one or more places in the specification, those embodiments or examples do not necessarily address any, much less all, of those deficiencies. In other words, different embodiments or examples of the invention may address deficiencies that may not be discussed in the specification. Some embodiments or examples may only partially address some deficiencies or just one deficiency in the prior art.

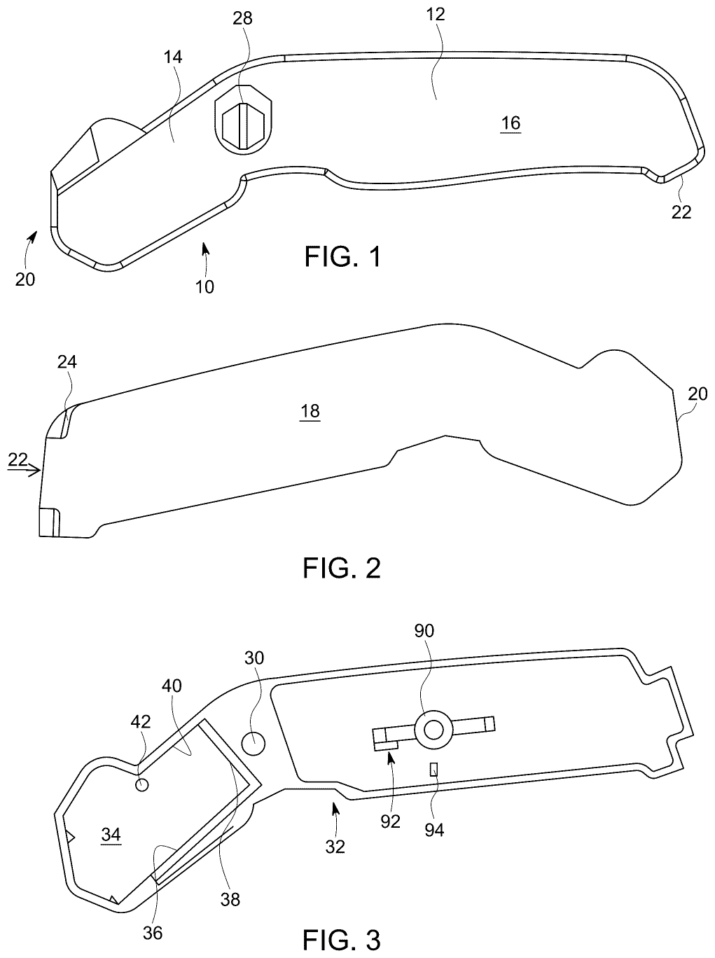

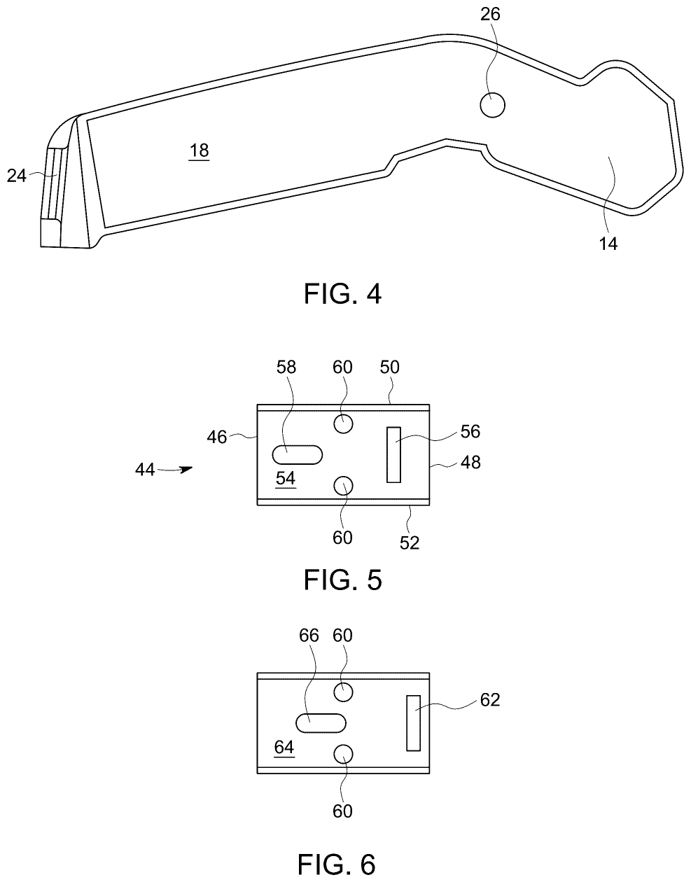

Referring to FIG. 1, a dual blade-depth carpet knife 10 is shown in the closed position. The knife includes a body portion 12 and a head 14. The knife 10 includes a front cover 16 (FIGS. 1 and 4) and a rear cover 18 (FIGS. 2 and 3) with the knife having a first end 20 and a second end 22. The interior of the knife is generally hollow to receive a blade and to provide for storage of blades and blade-containing cartridges as will be described in greater detail. The knife is preferably formed of plastic as is conventional with utility knives in general.

The front cover 16 and rear cover 18 are conveniently coupled together by a pivot 24 at the second end. A screw 26 extends through the front cover 16 and includes a gripping means 28 on the outside of the knife. A threaded recess 30 within the interior of the rear cover is positioned to receive and engage the screw 26 such that the front and rear covers may be secured together by the rotation of the screw.

The interior of the knife, and preferably the interior 32 of the head 14 of the rear cover, includes a generally rectangular recess 34. The recess extends inwardly from the first end 20 toward the second end 22 and is bounded on three sides, preferably the bottom, the interior end, and the top, by three upwardly extending shoulders 36, 38 and 40 respectively. The shoulder 40 may be the interior top of the head of the knife. An optional magnet 42 may be preferably positioned in the base of the recess such as adjacent the top shoulder 40.

Referring next to FIGS. 5 and 6, a blade positioning member such as a dual position insert 44 has a first end 46, a second end 48 with a length therebetween, a top 50 and a bottom 52 as illustrated in FIG. 5. The blade positioning member is preferably made of metal or includes magnetizable material. In FIG. 6, the insert 44 differs relative to the insert of FIG. 5 as will now be explained.

The first side 54 of the insert or blade positioning member is illustrated in FIG. 5 and includes a generally upward projection 56 extending in a direction between the top and bottom of the insert, transverse to the insert length, and with the ends of the projection preferably spaced inwardly from the top and bottom of the insert. The insert includes an elongated projection 58 extending in a direction generally from one end to the other end of the insert in a direction toward the projection 56 along the length of the insert. The projection 58 is thus illustrated as parallel to the elongated direction of the insert, from one end to the other end. Upper and lower circular recesses 60 are provided on the base of the insert to assist in engaging the magnet 42.

Referring next to FIG. 6, a generally upward projection 62 is provided on the second side 64 of the insert. The projection 62 extends between the top and bottom of the insert with the ends of the projection preferably spaced inwardly from the top and bottom of the insert, for example transverse to the length of the insert. The insert includes an elongated projection 66 extending in a direction generally from the one end of the insert toward the other end of the insert, in a direction toward the projection 62, for example parallel to the length of the insert. Again, upper and lower circular recesses 60 are provided on the base of the insert to assist in engaging the magnet 42.

Comparing FIGS. 5 and 6, the upward projection 62 on the one side of the insert (FIG. 6) is closer to the nearest end of the insert when compared to the distance between the upward projection 56 on the other side of the insert and the nearest end. (FIG. 5) Correspondingly, one end of the projection 66 on the second side 64 of the insert 44 (FIG. 6) is a greater distance from the nearest end 46 of the insert when compared to the distance between the end of the projection 58 on the first side 54 of the insert and the nearest end. (FIG. 5)

Stated alternatively, projection 56 is offset inwardly from the nearest end on the first side 54 of the insert (FIG. 5) a greater amount than the offset of the projection 62 from the nearest end on the second side 64 of the insert. (FIG. 6)

Correspondingly, the projection 58 is offset inwardly from the nearest end on the first side of the insert 54 (FIG. 5) a lesser amount than the offset of the projection 66 from the nearest end on the second side 64 of the insert (FIG. 6).

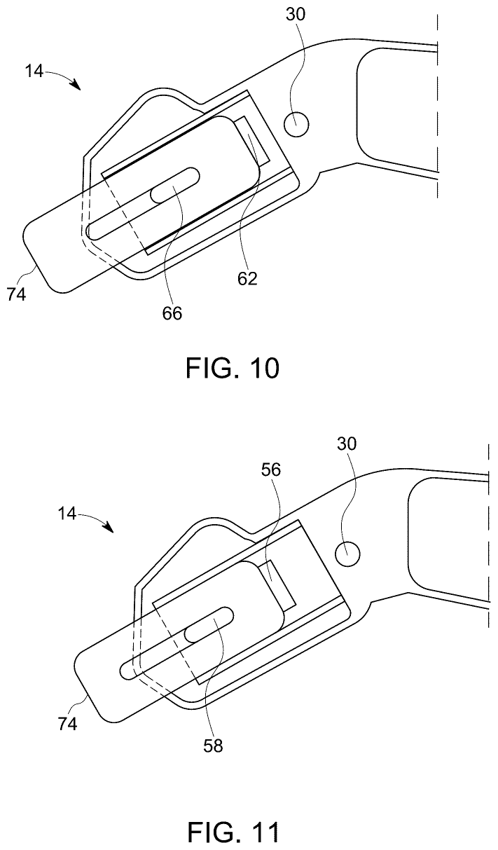

The blade positioning member or insert 44 may thus have two positions. One position would be for the projection 62 to be closer to the shoulder 38 in the recess 34, such as in FIG. 10. When a blade is placed on the insert, and the insert positioned in the head as in FIG. 10, the end 74 of the blade 68 extends a first distance beyond the first end 20 of the knife head 14. In a second position, the projection 56 is closer to the shoulder 38 in the recess 34, such as in FIG. 11. Again, when a blade is positioned in the insert, and the insert positioned in the head as in FIG. 11, the end 74 of the blade extends a second distance beyond the first end 20 of the knife head 14.

It should be appreciated that the difference between the first distance and second distance that the blade extends beyond the first end of the knife, depends on whether the blade is placed on the first side 54 or the second side 64 of the insert. The difference in blade extension corresponds to the difference in distance between the projection 56 and the nearest end of the insert compared to the distance between the project 62 and the nearest end of the insert.

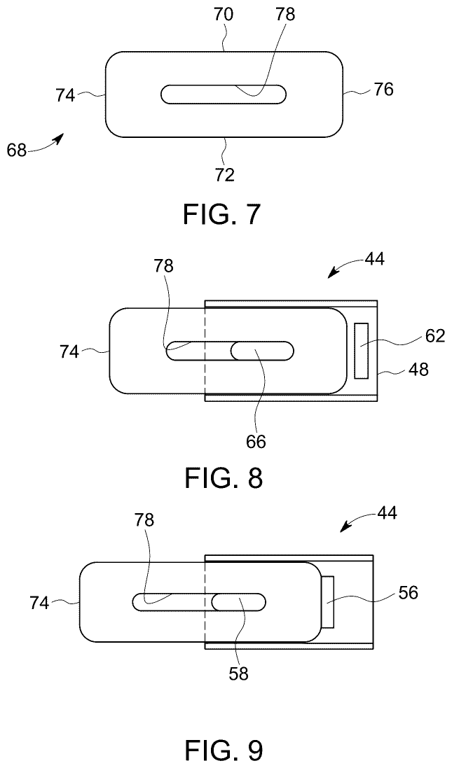

Referring next to FIG. 7, a conventional carpet blade 68 is formed of metal and has upper and lower elongated cutting edges 70, 72. The blade is elongated between first and second blade ends 74, 76, and has an elongated opening, typically an elliptical opening 78 therethrough. The elongated opening may be centered relative to the cutting edges 70, 72, and relative to the ends 74, 76 as is conventional. The length of the opening 78 is greater than the length of the projections 58, 66, on the blade positioning member.

FIG. 8 illustrates the blade 68 positioned on the second side 64 of the insert 44 with the insert oriented as in FIG. 6. The blade end 76 is adjacent the upward projection 56 and the projection 58 of the insert extends through the opening 78 in the blade. The projection 56 serves to limit or restrict inward movement of the blade 68 away from the knife end 20. The length of the opening 78 in the blade is greater than the length of the projection 66. In the illustration of FIG. 8, one end of the projection 66 engages one end of the opening 78 to limit or restrict outward movement of the blade. Thus, the combination of the projections and blade opening cooperate to limit or restrict both inward and outward blade movement.

FIG. 9 illustrates the blade 68 positioned on the first side 54 of the insert 44 with the insert oriented as in FIG. 5. The blade end 76 is adjacent the upward projection 56 and the projection 58 of the insert extends through the opening 78 in the blade. The projection 56 serves to limit or restrict inward movement of the blade 68 away from the knife end 20. The length of the opening 78 in the blade is greater than the length of the projection 66. In the illustration of FIG. 9, one end of the projection 58 engages one end of the opening 78 to limit or restrict outward movement of the blade. Thus, the combination of the projections and blade opening cooperate to limit or restrict both inward and outward blade movement.

Referring next to FIG. 10, the blade is positioned on the insert as in FIG. 8 and the insert is positioned within the recess 34. A portion of the blade extends outwardly from the first end 20 of the knife for use in cutting carpet.

Referring next to FIG. 11, the blade is positioned on the insert as is FIG. 9 and the insert is positioned within the recess 34. A portion of the blade extends outwardly from the first end 20 of the knife for use in cutting carpet. The blade in FIG. 11 extends outwardly a greater distance from the end of the knife when compared to the blade in FIG. 10 as described above.

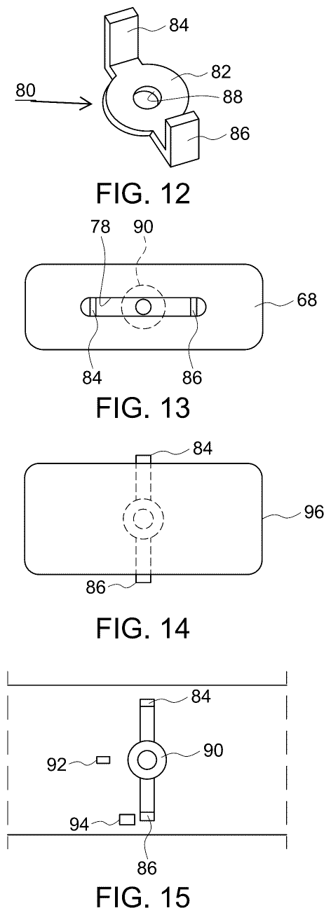

Referring next to FIG. 3 and FIGS. 12 through 15, the feature of storage of used and/or replacement blades and/or blade cartridges will now be explained. As discussed above, the dual blade-depth knife does not have a fully retractable blade position, i.e., no position where the blade is entirely within the knife head. Thus, for safety, the blade should be removed when the knife is being stored. Of course, it is possible to store the knife with part of the blade exposed but it is preferable to remove the blade.

The present knife includes means for storing one or more blades and/or for storage a conventional package or cartridge containing multiple blades. The knife includes a U-shaped blade holder 80 having a base 82 and opposed legs 84, 86. The blade holder base includes an aperture 88 so that the holder may be movably attached, preferably for rotational movement, to the interior of the rear cover 18 within the knife body 12. The spacing between the opposed legs 84, 86 is less than the length of the opening 78 in the knife blade.

The interior of the rear cover includes a projection 90 to engage the aperture 88 in the blade holder 80 such that the blade holder may rotate relative to the knife handle. The wall includes a projection 92, positioned slightly below the middle of the knife body. The projection 92 limits counterclockwise rotation of the blade holder 80. Positioning the projection slightly below the middle of the knife body allows the holder to rotate to a horizontal position as illustrated in FIG. 3 and FIG. 13.

The interior of the rear cover includes a projection 94, positioned slightly to the side relative to a vertical position of the holder to limit clockwise rotation of the blade holder. Positioning the projection slightly to the side as illustrated in FIG. 3 and FIG. 15 allows the holder to rotate to a vertical position.

The blade holder 80 in the horizontal position, as in FIG. 3 and FIG. 13 permits storage of one or more blades 68 thereon as the spacing between the holder legs 84, 86 is slightly less than the length of the opening 78 in the blade.

It is conventional for multiple blades to be sold in a generally rectangular cartridge 96. The cartridge may be stored within the knife handle by rotation of the blade holder to the vertical position, as illustrated in FIG. 14 and FIG. 15, with the cartridge between the legs 84, 86 of blade holder 80 as illustrated in FIG. 14.

The knife is opened by unscrewing the front cover from the rear cover and conveniently pivot the front cover away from the rear cover. With the covers thus separated, blades may be positioned, removed, stored, etc. The front and rear covers are then closed and secured together.

Each embodiment or variation disclosed herein may be used or otherwise combined with any other embodiment or variation.

Although the invention has been described with reference to specific embodiments, examples and variations, it will be understood by those skilled in the art that various changes may be made and/or equivalents may be substituted without departing from the spirit and scope of the invention and/or without departing from the essential teachings of the invention. The invention, therefore, should be limited only by the scope of the claims and equivalents thereof.

1. A dual blade-depth knife having a head, a body, and a first end at one end of the head, the improvement comprising:
a blade positioning member,
the blade positioning member for retaining a blade in a first position with a blade end at a first distance from said first end;
said blade positioning member for retaining a blade in a second position with a blade end at a second distance from said first end; and
said first and second positions being offset relative to each other in a direction outwardly from the head.

2. The dual blade-depth knife according to claim 1, wherein the knife excludes a fully retractable blade position.

3. The dual blade-depth knife according to claim 2, wherein the blade positioning member includes a first stop for retaining a blade in said first position, and a second stop for retaining a blade in said second position, and wherein said first and second stops are offset laterally relative to each other.

4. The dual blade-depth knife according to claim 1

5. wherein the blade positioning member includes a first stop for retaining a blade in said first position, and a second stop for retaining a blade in said second position, and wherein said first and second stops are offset relative to each other

6. The dual blade-depth knife according to claim 1, wherein said blade positioning member is in the knife head.

7. The dual blade-depth knife according to claim 1, wherein said blade positioning member is invertible or reversible.

8. The dual blade-depth knife according to claim 1, wherein said blade positioning member has a first length and a first stop generally transverse to said first length.

9. The dual blade-depth knife according to claim 6, wherein said blade positioning member has a second stop generally parallel to said first length.

10. The dual blade-depth knife according to claim 9, wherein at least one of said stops is elliptical.

11. The dual blade-depth knife according to claim 1, wherein one of said blade positioning member and said knife includes a magnet.

12. The dual blade-depth knife according to claim 1, wherein said head of the knife includes a recess and said blade positioning member is at least partially in said recess.

13. The dual blade-depth knife according to claim 1, wherein said knife includes a magnet and said blade positioning member is formed at least in part of magnetizable material.

14. The dual blade-depth knife according to claim 1, wherein said knife includes storage for blades.

15. The dual blade-depth knife according to claim 14, wherein said knife includes a holder for storage of blades, said holder having two discrete positions, each position for storage of blades.

16. The dual blade-depth knife according to claim 1, wherein the blade positioning member limits both inward and outward movement of the blade when the blade positioning member is retaining a blade in said first position and limits both inward and outward movement of the blade when the blade positioning member is retaining a blade in said second position.

17. A knife having a head, a body, and a first end at one end of the head, the improvement comprising: an internal holder for storage of blades, said holder having two discrete positions with each position for storage of blades.

18. The knife according to claim 17, wherein said holder is rotatable between said first position and said second position.

19. The knife according to claim 17, wherein said holder is positioned within the knife body.

20. A blade positioning member for a knife, the knife having a head and a body, wherein either (a) or (b):
(a) the blade positioning member is integral with the knife head; or
(b) the blade positioning member is removable;
and, wherein at least one of (c), (d), or (e) wherein the blade positioning member:
(c) the blade positioning member is reversible;
(d) the blade positioning member provides two positions for a blade;
(e) the blade positioning member provides positions for two non-identical blades.

21. The blade positioning member of claim 20, including both (a) and (c).

22. The blade positioning member of claim 20, including both (b) and (c).

23. The blade positioning member of claim 20, including both (b) and (d).
